(19) United States
(12) Patent Application Publication
(10) Pub. No.: US 2023/0264605 A1
(43) Pub. Date: Aug. 24, 2023

(54) FUEL CELL VEHICLE WITH DYNAMIC DC BUS VOLTAGE CONTROL

(71) Applicant: Ford Global Technologies, LLC, Dearborn, MI (US)

(72) Inventors: Ming CHENG, Northville, MI (US); Rajit JOHRI, San Francisco, CA (US); Thomas J. COUPAR, Ann Arbor, MI (US); Julio OROZCO SANTOS COY, Aachen NRW (DE); Michael David BEENEY, Canton, MI (US)

(73) Assignee: Ford Global Technologies, LLC, Dearborn, MI (US)

(21) Appl. No.: 17/676,805

(22) Filed: Feb. 21, 2022

(51) Int. Cl. B60L 58/40; B60L 15/20

(52) U.S. Cl. CPC B60L 58/40; B60L 15/2045; B60L 2210/40; B60L 2210/12; B60L 2210/14; B60L 2240/421; B60L 2240/423; B60L 2240/425

(57) ABSTRACT

A vehicle includes a fuel cell stack, a traction battery, at least one DC/DC converter electrically coupling the fuel cell stack and the traction battery to a DC bus, an electric machine coupled to the DC bus via an inverter, and a controller programmed to control the at least one DC/DC converter to provide a DC bus voltage to maximize efficiency of the electric machine based on torque, rotational speed, and temperature of the electric machine.

### TECHNICAL FIELD

This disclosure relates to a fuel cell vehicle having dynamic control of DC bus voltage based on electric machine efficiency.

### BACKGROUND

Fuel cell vehicles harness a chemical reaction between hydrogen and oxygen to generate DC power that may be stored in a traction battery pack and/or converted to AC to power one or more electric machines to propel the vehicle. A DC/DC converter may be used to increase or decrease the voltage provided from the fuel cell or provided to/from the traction battery to a level suitable for use in powering the electric machines or other vehicle components or accessories. Many battery electric and hybrid electric vehicles have a DC bus directly connected to the battery pack. The DC bus voltage is dependent on the battery pack SOC (state of charge) and current battery operating conditions (being charged/discharged) and is not controllable. The operational efficiency of the electric machines changes along with the requested torque and the DC bus voltage, neither of which is independently controllable.

### SUMMARY

Embodiments according to the disclosure include a vehicle having a fuel cell stack, a traction battery, at least one DC/DC converter electrically coupling the fuel cell stack and the traction battery to a DC bus, an electric machine coupled to the DC bus via an inverter, and a controller programmed to control the at least one DC/DC converter to provide a DC bus voltage based on torque, rotational speed, and temperature of the electric machine. The at least one DC/DC converter may include a first DC/DC converter coupling the fuel cell stack to the DC bus and a second DC/DC converter coupling the traction battery to the DC bus. The vehicle may include a second fuel cell stack and a second traction battery, wherein the at least one DC/DC converter comprises a first DC/DC converter coupling the traction battery to the DC bus, and a second DC/DC converter coupling the second traction battery to the DC bus. The at least one DC/DC converter may include a third DC/DC converter coupling the fuel cell stack to the DC bus, and a fourth DC/DC converter coupling the second fuel cell stack to the DC bus. The controller may be further programmed to retrieve a target DC bus voltage from a stored lookup table representing a relationship between efficiency of the electric machine and electric machine torque, rotational speed, and temperature. The controller may be further programmed to apply DC bus constraints to the target DC bus voltage retrieved from the lookup table, and control the at least one DC/DC converter based on a resulting target DC bus voltage. The controller may be further programmed to control the at least one DC/DC converter to provide a target DC bus voltage to maximize efficiency of the electric machine for the electric machine torque, rotational speed, and temperature.

Embodiments may also include a method for controlling a fuel cell vehicle having a fuel cell stack and a traction battery coupled by at least one DC/DC converter to a DC bus, and an electric machine coupled to the DC bus via an inverter. The method may include, by a controller, controlling voltage of the DC bus by controlling the at least one DC/DC converter in response to a requested electric machine torque, electric machine rotational speed, and electric machine temperature. The method may also include retrieving a target DC bus voltage from a stored lookup table representing a relationship between efficiency of the electric machine and the electric machine torque, the electric machine rotational speed, and the electric machine temperature. The fuel cell vehicle may include a second traction battery where the at least one DC/DC converter includes a first DC/DC converter coupling the traction battery to the DC bus, and a second DC/DC converter coupling the second traction battery to the DC bus. The method may also include applying upper and lower limits to the target DC bus voltage based on a state of charge of the traction battery and a state of charge of the second traction battery. The fuel cell vehicle may include a second fuel cell stack where the at least one DC/DC converter includes a third DC/DC converter coupling the fuel cell stack to the DC bus and a fourth DC/DC converter coupling the second fuel cell stack to the DC bus. The method may include controlling the first, second, third, and fourth DC/DC converters based on the target DC bus voltage.

In one or more embodiments, a fuel cell system includes a first fuel cell stack coupled by a first DC/DC converter to a DC bus, and a controller programmed to control the first DC/DC converter to supply a target DC voltage to the DC bus, the target DC voltage controlled to maximize efficiency of an electric machine coupled to the DC bus for a requested electric machine torque, an electric machine rotational speed, and an electric machine temperature. The fuel cell system may also include a second DC/DC converter and a traction battery coupled to the DC bus by the second DC/DC converter, wherein the controller is further programmed to control the second DC/DC converter to supply the target DC voltage to the DC bus. The fuel cell system may also include a second fuel cell coupled by a third DC/DC converter to the DC bus, wherein the controller is further programmer to control the third DC/DC converter to supply the target DC voltage to the DC bus. The controller may be programmed to retrieve the target DC voltage from a stored lookup table representing a relationship between the efficiency of the electric machine and the requested electric machine torque, the electric machine rotational speed, and the electric machine temperature. The controller may be further programmed to adjust the target DC voltage retrieved from the stored lookup table based on state of charge of the traction battery. The fuel cell system may also include a second traction battery coupled to the DC bus by a third DC/DC converter, wherein the controller is programmed to control the third DC/DC converter to supply the target DC voltage to the DC bus. The fuel cell system may also include a second fuel cell coupled by a fourth DC/DC converter to the DC bus, wherein the controller is programmed to control the fourth DC/DC converter to supply the target DC voltage to the DC bus.

One or more embodiments according to the disclosure may have associated advantages. For example, embodiments according to the disclosure may operate the vehicle electric machines near peak efficiency under more operating conditions by dynamically controlling the DC bus voltage. The improvement in electric machine efficiency may improve the overall vehicle efficiency with an associated reduction in hydrogen consumption.

### BRIEF DESCRIPTION OF THE DRAWINGS

FIG. 1 is block diagram of a representative fuel cell vehicle with dynamic DC bus voltage control.

FIG. 2 is a simplified schematic of a representative DC/DC converter and inverter used to control DC bus voltage and power a vehicle electric machine.

FIG. 3 is a block diagram illustrating a representative fuel cell system as shown in the vehicle diagram of FIG. 1.

FIG. 4 is a block diagram illustrating operation of a representative system or method for dynamic DC bus voltage control.

### DETAILED DESCRIPTION

Embodiments of the present disclosure are described herein. It is to be understood, however, that the disclosed embodiments are merely examples and other embodiments can take various and alternative forms. The figures are not necessarily to scale and may be simplified; some features could be exaggerated, minimized, or omitted to show details of particular components. Therefore, specific structural and functional details disclosed herein are not to be interpreted as limiting, but merely as a representative basis for teaching one skilled in the art to variously employ the claimed subject matter. As those of ordinary skill in the art will understand, various features illustrated and described with reference to any one of the figures can be combined with features illustrated in one or more other figures to produce embodiments that are not explicitly illustrated or described, but within the scope of the claimed subject matter. The combinations of features illustrated provide representative embodiments for typical applications. Various combinations and modifications of the features consistent with the teachings of this disclosure, however, could be desired for particular applications or implementations.

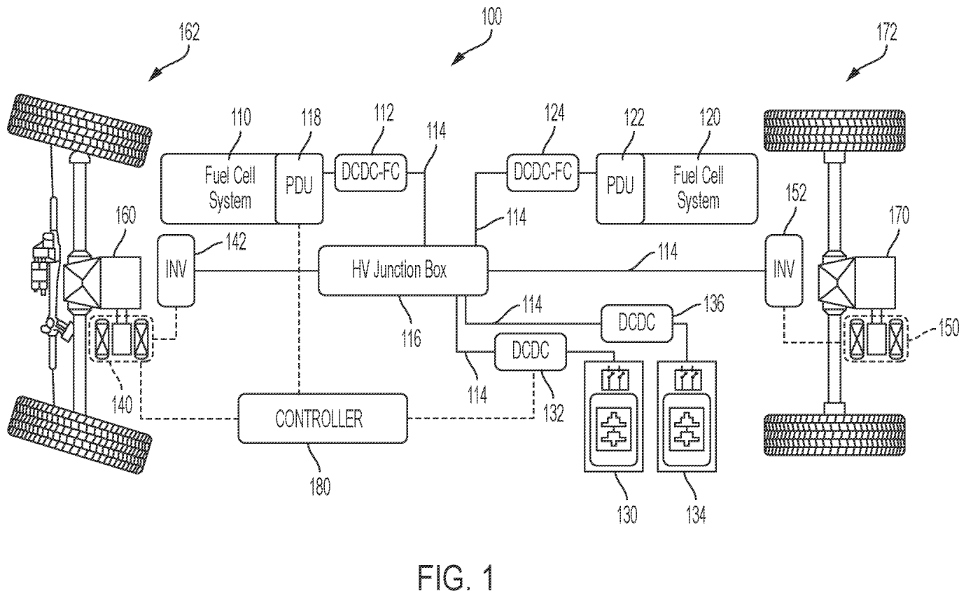

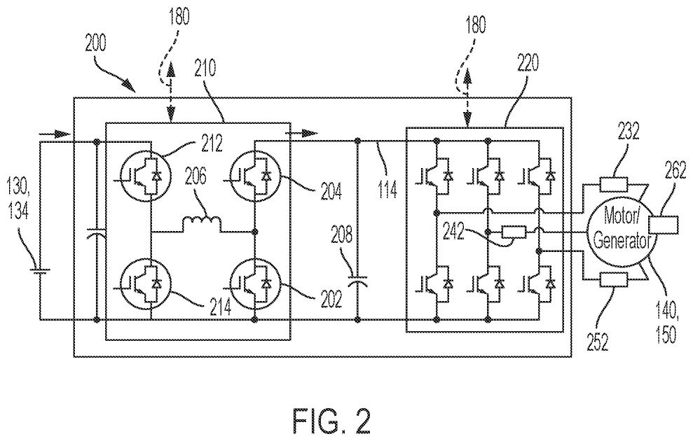

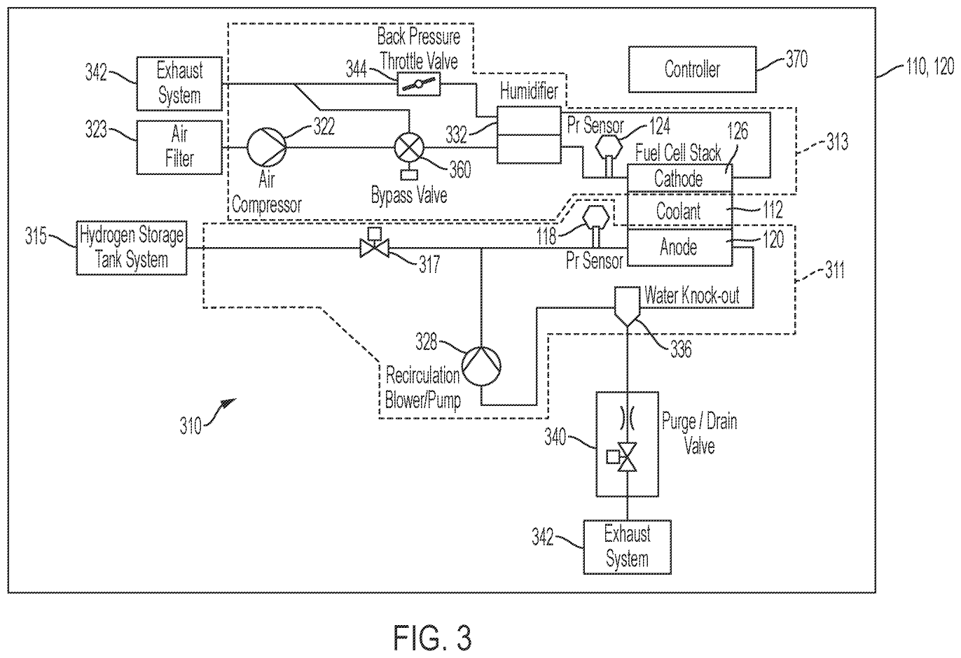

FIG. 1 is block diagram of a representative fuel cell vehicle with dynamic DC bus voltage control to maximize electric machine efficiency according to the present disclosure. Fuel cell vehicle 100 includes a first fuel cell system 110 electrically coupled by an associated DC/DC converter 112 to a DC bus 114. A representative DC/DC converter is illustrated and described with reference to FIG. 2. The DC bus 114 is connected to various vehicle components via a high-voltage (HV) junction box 116. Fuel cell system 110 may include a dedicated controller 118, such as a fuel cell control unit (FCCU) or similar control module. Alternatively, one or more functions of the fuel cell system may be controlled by another general-purpose vehicle controller, such as controller 180, for example. Controller 180 may control at least one DC/DC converter, such as DC/DC converter 112 to provide a target DC bus voltage as described in greater detail herein. Additional details of a representative fuel cell system 110 are illustrated and described with reference to FIG. 3.

Representative fuel cell vehicle 100 may include a second fuel cell system 120 with an associated controller or control module 122. Fuel cell system 120 is electrically coupled to DC bus by an associated DC/DC converter 124.

Fuel cell vehicle 100 includes a first traction battery or battery pack 130 electrically coupled to DC bus 114 by an associated DC/DC converter 132. Vehicle 100 may also include a second traction battery 134 electrically coupled to DC bus 114 by an associated DC/DC converter 136. At least one of the DC/DC converters 112, 124, 132, and 134 may be controlled by an associated controller 180 to supply a target DC bus voltage to DC bus 114 to optimize efficiency of one or more electric machines, such as electric machines 140, 150 based on respective electric machine requested torque, electric machine rotational speed, and electric machine temperature. The target DC bus voltage may be retrieved from one or more stored lookup tables representing a relationship between efficiency of the electric machines 140, 150 and the associated electric machine requested torque, rotational speed, and temperature.

Fuel cell vehicle 100 may include one or more electric machines, such as electric machine 140 and electric machine 150 electrically coupled to DC bus 114 by associated inverters 142, 152, and mechanically coupled to corresponding transmissions or gear boxes 160, 170 to propel the vehicle wheels 162, 172, respectively. Inverters 142, 152 convert DC power of DC bus 114 to three-phase AC power for the electric machines 140, 150 as generally known and described in greater detail with reference to FIG. 2. Controller 180 may determine a requested electric machine torque for electric machine 140 and/or electric machine 150 and may monitor and/or control electric machine rotational speed. The current rotational speed, and current temperature of electric machines 140, 150 may be measured by associated sensors (not shown). The requested torque, current rotational speed, and current temperature of electric machines 140 and/or 150 may be used to determine a target DC bus voltage retrieved from a lookup table stored in one or more non-transitory memory devices associated with controller 180 to maximize electric machine efficiency as previously described, and described in greater detail herein.

FIG. 2 is a simplified schematic of a representative combined DC/DC converter and inverter 200 used to control DC bus voltage of DC bus 114 and power a vehicle electric machine 140 or 150. While illustrated as a combined DC/DC converter and inverter, the DC/DC converter portion 210 and inverter portion 220 may be separated as generally represented in the block diagram of FIG. 1 in various applications. Similarly, while system 200 is illustrated coupled to a traction battery, such as traction battery 130, 134, a similar arrangement may be used to couple the DC/DC converter 210 to a fuel cell stack of a fuel cell system, such as represented by fuel cell systems 110, 120 of FIG. 1. As such, any references to a traction battery in the description apply equally to a fuel cell stack of a fuel cell system.

A traction battery 130 or 134 (or fuel cell system 110, 120) is coupled to DC/DC converter 210 of system 200. One or more contactors or high voltage switches (not shown) controlled by an associated controller, such as controller 180 (FIG. 1), may be operated to selectively connect battery voltage from battery 130, 134 to system 200 after completing various diagnostic routines as generally understood by those of ordinary skill in the art. These high voltage switches may be implemented by relays, insulated gate bipolar junction transistors (IGBTs), metal oxide semiconductor field effect transistors (MOSFETs), bipolar junction transistors (BJTs), and/or other electro-mechanical or solid-state switches. The system may include a pre-charge circuit to limit the current flow from traction battery 130, 134 while the system is powering up.

System 200 may include DC/DC or buck-boost converter circuitry 210 upstream of inverter components 220 to power one or more electric machines 140, 150. The power electronics module 200 may include a boost circuit with an inductor 206, a switch 212 to charge an electric field in the inductor 206, and a switch 214 to discharge the electric field and change the voltage supplied to the DC bus 114 to drive the inverter 220 and associated electric machine 140, 150. This power electronics module 200 may also include a buck circuit using inductor 206 and switches 202 and 204. This DC/DC converter circuit 210 will convert the supplied DC voltage to an operational voltage which may be greater than or less than the supplied DC voltage depending on the operation of switches 202, 204, 212, 214 that are controlled by an associated controller 180 to provide a target DC bus voltage to DC bus 114. The buck-boost power converter 210 may use IGBTs, BJTs, MOSFETs, relays, or other electro-mechanical or solid-state switches. The use of IGBTs with Fast Recovery Diodes (FRDs) in this diagram is representative and may be accomplished using MOSFETs, BJTs, or other electro-mechanical or solid-state switches. The capacitor 208, sometimes referred to as a DC link capacitor, is used to filter the voltage generated by the DC/DC converter so that the operational voltage applied to DC bus 114 and attached components such as the inverter 210 is generally stable. This buck-boost circuit is intended to change the voltage of a voltage source, such as a battery or fuel cell (having a voltage greater than 60V DC), to an operating voltage different than the source voltage and is dynamically controlled by the controller 180 to provide a DC bus voltage that optimizes efficiency of electric machine 140, 150 for current electric machine requested torque, rotational speed, and temperature. An example of this voltage conversion is converting a high voltage source of 90-400 volts to a dynamically varying operating voltage of 100-1200 volts to improve operating efficiency of electric machine 140, 150.

As previously described, inverter 220 converts the DC voltage/current to three-phase AC voltage/current provided to electric machine 140, 150. As described in greater detail herein, inverter 220 communicates with an associated controller as indicated at 228 to control the transistor pairs to generate a desired voltage amplitude and waveform across the various legs connecting the inverter 220 to the machine 140, 150 and/or other loads. Current sensors 232, 242, 252 associated with each phase/leg may optionally be provided to monitor current flow. Electric machine 140, 150 may include a resolver or other rotational position sensor 262 that provides a corresponding signal indicative of rotational position/speed of the rotor of electric machine 140, 150. A temperature sensor (not shown), may also be included to provide a corresponding signal indicative of temperature of electric machine 140, 150.

FIG. 3 is a block diagram illustrating a representative fuel cell system 110, 120 as shown in the vehicle diagram of FIG. 1. Fuel cell system 110, 120 includes an anode subsystem 311 configured to provide hydrogen fuel at a desired pressure, flow, and humidity to a fuel cell stack 312. Likewise, a cathode subsystem (loop) 313 is configured to provide oxygen (air) at a desired pressure, flow, and humidity to the fuel cell stack 312. As known in the art, electrical energy may be generated by the fuel cell stack 312 as the hydrogen and oxygen react. This electrical energy may be used to provide power to through an associated DC/DC converter 112, 124 to the DC bus 114.

Fuel supply from a hydrogen storage tank system 315 is enabled by an associated controller 370 with the supply pressure to the fuel cell stack 312 controlled by a pressure control device 317 that may be controlled by controller 370. The pressure control device 317 takes input from a pressure sensor 318 at the inlet of the fuel cell stack anode 320 to control the hydrogen fuel pressure to the stack 312. An air compressor 322 controlled by controller 370 increases the ambient pressure of air filtered by air filter 323 based on input from an air pressure sensor 324 at the inlet of the fuel cell stack cathode 326. Outlet airflow from compressor 322 may pass through bypass valve 360 before passing through humidifier 332 to supply cathode 326 with air (oxygen). Bypass valve 360 is controlled by controller 370 to selectively allow at least a portion of the airflow from compressor 322 to be directed to exhaust system 342 and bypass fuel cell stack 312. The system is generally controlled such that the pressure on either side of the fuel cell membrane (not shown) between anode 320 and cathode 326 is maintained within a certain tolerance, for example around 600 mbar. The tolerance may vary depending upon the fuel cell stack design. Any overpressure or under pressure may result in system shut down to protect the fuel cell stack membrane.

For efficient power generation, the fuel cell stack 312 may require humidified gases. Anode gas humidity may be maintained by recirculating the anode gas mixture from the fuel cell stack outlet using a blower 328 to mix feed gas from the hydrogen storage tank system 315 with the recirculated hydrogen. Cathode gas (air) humidity is maintained by passing air through a humidifier 332.

At the anode side of the fuel cell stack outlet, a water knock-out 336 and purge/drain valve 340 are provided to remove water from the anode outlet. This removed water is passed to exhaust system 342 of the vehicle. At the cathode side of the fuel cell stack outlet, a back pressure throttle valve 344 fluidly connects the humidifier 332 and the exhaust system 342. Position of throttle valve 344 and compressor 322 are controlled by controller 370 to maintain a desired cathode subsystem pressure.

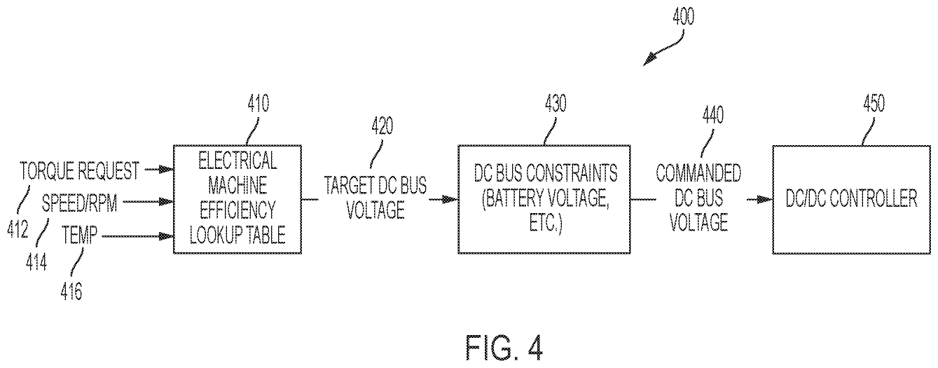

Controller 370 may be implemented as a dedicated FCCU or may cooperate with one or more other controllers, such as a vehicle controller 180 to perform one or more control functions described herein. Control logic, functions, code, software, strategy etc. performed by one or more processors or controllers 170, 180 and/or an FCCU may be represented by block diagrams or flow charts such as shown in FIG. 4. The representative control strategy, algorithm, and/or logic for operation of a system or method for dynamic control of DC bus voltage to optimize electrical machine efficiency according to the disclosure that may be implemented using one or more processing strategies such as event-driven, interrupt-driven, multi-tasking, multi-threading, and the like. As such, various steps or functions illustrated or described may be performed in the sequence as illustrated or described, in parallel, or in some cases omitted. Although not always explicitly illustrated or described, one of ordinary skill in the art will recognize that one or more of the steps or functions may be repeatedly performed depending upon the particular processing strategy being used. Similarly, the order of processing is not necessarily required to achieve the features and advantages described herein, but is provided for ease of illustration and description. The control logic may be implemented primarily in software executed by one or more microprocessor-based controllers or control modules that may communicate with one another and distribute various control tasks or functions depending upon the particular application and implementation. When implemented in software, the control logic may be provided in one or more non-transitory computer-readable storage devices or media having stored data representing code or instructions executed by a computer to control the vehicle or its subsystems. The storage devices may include various working variables, parameters, or other data, such as a lookup table used to determine a desired or target DC bus voltage as described herein.

FIG. 4 is a block diagram illustrating operation of a representative system or method for dynamic DC bus voltage control to optimize electrical machine efficiency. System or method 400 include a multi-dimensional array or lookup table 410 that represents the relationship between the efficiency of the electric machine based on the requested torque 412, rotational speed 414, and temperature 416. The controller monitors these electric machine parameters in real time and accesses the stored lookup table or array 410 to retrieve or determine a corresponding target or desired DC bus voltage 420. The stored lookup table or array 410 may be populated with empirically determined values offline in advance to find an optimal DC bus voltage for different levels of target or requested motor torque, speed, and temperature. These values are then stored for access by the controller during vehicle operation.

DC bus constraints may be applied at 430 to the retrieved target DC bus voltage 420 to assure that the target voltage does not violate any applicable constraints (battery power, etc.). The resulting limited or constrained value forms the command DC bus voltage as represented at 440 used by the DC/DC controller 450 to control at least one of the DC/DC converters as previously described. Controller 450 may be a dedicated controller, control module, etc. or may be implemented by another multi-purpose controller, such as controller 180, for example. The use of controllable DC/DC converters between the vehicle fuel cells and the DC bus, as well as between the vehicle traction batteries and the DC bus provides for the DC bus voltage to be controlled to a desired value, which can be dynamically varied based on operating conditions of the electric machine(s) to improve operating efficiency over more operating conditions as compared to various prior art implementations.

As generally illustrated in FIGS. 1-4 and described above, a method for controlling a fuel cell vehicle having a fuel cell stack and a traction battery coupled by at least one DC/DC converter to a DC bus, and an electric machine coupled to the DC bus via an inverter, includes controlling voltage of the DC bus by controlling the at least one DC/DC converter in response to a requested electric machine torque, electric machine rotational speed, and electric machine temperature. The method may include retrieving a target DC bus voltage from a stored lookup table representing a relationship between efficiency of the electric machine and the electric machine torque, the electric machine rotational speed, and the electric machine temperature.

The processes, methods, or algorithms disclosed herein can be deliverable to/implemented by a processing device, processor, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as RAM devices, FLASH devices, MRAM devices and other non-transitory optical media.

Alternatively, the processes, methods, or algorithms can be embodied in whole or in part using suitable hardware components, such as Application Specific Integrated Circuits (ASICs), Field-Programmable Gate Arrays (FPGAs), state machines, controllers, or any other hardware components or devices, or a combination of hardware, software, and firmware components. While the algorithms, processes, methods, or steps may be illustrated and/or described in a sequential manner, various steps or functions may be performed simultaneously or based on a trigger or interrupt resulting in a different sequence or order than illustrated and described. Some processes, steps, or functions may be repeatedly performed whether or not illustrated as such. Similarly, various processes, steps, or functions may be omitted in some applications or implementations.

The representative embodiments described are not intended to encompass all possible forms within the scope of the claims. The words used in the specification are words of description rather than limitation, and it is understood that various changes can be made consistent with the teachings of the disclosure within the scope of the claimed subject matter. As previously described, one or more features of various embodiments can be combined to form further embodiments that may not be explicitly described or illustrated. Although embodiments that have been described as providing advantages over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A vehicle comprising:
a fuel cell stack;
a traction battery;
at least one DC/DC converter electrically coupling the fuel cell stack and the traction battery to a DC bus;
an electric machine coupled to the DC bus via an inverter; and
a controller programmed to control the at least one DC/DC converter to provide a DC bus voltage based on torque, rotational speed, and temperature of the electric machine.

2. The vehicle of claim 1 wherein the at least one DC/DC converter comprises a first DC/DC converter coupling the fuel cell stack to the DC bus and a second DC/DC converter coupling the traction battery to the DC bus.

3. The vehicle of claim 1 further comprising a second fuel cell stack and a second traction battery, wherein the at least one DC/DC converter comprises a first DC/DC converter coupling the traction battery to the DC bus, and a second DC/DC converter coupling the second traction battery to the DC bus.

4. The vehicle of claim 3 wherein the at least one DC/DC converter comprises a third DC/DC converter coupling the fuel cell stack to the DC bus, and a fourth DC/DC converter coupling the second fuel cell stack to the DC bus.

5. The vehicle of claim 1 wherein the controller is further programmed to retrieve a target DC bus voltage from a stored lookup table representing a relationship between efficiency of the electric machine and electric machine torque, rotational speed, and temperature.

6. The vehicle of claim 5 wherein the controller is further programmed to apply DC bus constraints to the target DC bus voltage retrieved from the lookup table, and control the at least one DC/DC converter based on a resulting target DC bus voltage.

7. The vehicle of claim 1 wherein the controller is further programmed to control the at least one DC/DC converter to provide a target DC bus voltage to maximize efficiency of the electric machine for the electric machine torque, rotational speed, and temperature.

8. A method for controlling a fuel cell vehicle having a fuel cell stack and a traction battery coupled by at least one DC/DC converter to a DC bus, and an electric machine coupled to the DC bus via an inverter, the method comprising, by a controller:
controlling voltage of the DC bus by controlling the at least one DC/DC converter in response to a requested electric machine torque, electric machine rotational speed, and electric machine temperature.

9. The method of claim 8 further comprising:
retrieving a target DC bus voltage from a stored lookup table representing a relationship between efficiency of the electric machine and the electric machine torque, the electric machine rotational speed, and the electric machine temperature.

10. The method of claim 9 wherein the fuel cell vehicle includes a second traction battery and wherein the at least one DC/DC converter includes a first DC/DC converter coupling the traction battery to the DC bus, and a second DC/DC converter coupling the second traction battery to the DC bus.

11. The method of claim 10 further comprising applying upper and lower limits to the target DC bus voltage based on a state of charge of the traction battery and a state of charge of the second traction battery.

12. The method of claim 10 wherein the fuel cell vehicle includes a second fuel cell stack and wherein the at least one DC/DC converter includes a third DC/DC converter coupling the fuel cell stack to the DC bus and a fourth DC/DC converter coupling the second fuel cell stack to the DC bus.

13. The method of claim 12 wherein controlling voltage of the DC bus comprises controlling the first, second, third, and fourth DC/DC converters.

14. A fuel cell system, comprising:
a first fuel cell stack coupled by a first DC/DC converter to a DC bus; and
a controller programmed to control the first DC/DC converter to supply a target DC voltage to the DC bus, the target DC voltage controlled to maximize efficiency of an electric machine coupled to the DC bus for a requested electric machine torque, an electric machine rotational speed, and an electric machine temperature.

15. The fuel cell system of claim 14 further comprising:
a second DC/DC converter; and
a traction battery coupled to the DC bus by the second DC/DC converter, wherein the controller is further programmed to control the second DC/DC converter to supply the target DC voltage to the DC bus.

16. The fuel cell system of claim 15 further comprising:
a second fuel cell coupled by a third DC/DC converter to the DC bus, wherein the controller is further programmer to control the third DC/DC converter to supply the target DC voltage to the DC bus.

17. The fuel cell system of claim 15 wherein the controller is programmed to retrieve the target DC voltage from a stored lookup table representing a relationship between the efficiency of the electric machine and the requested electric machine torque, the electric machine rotational speed, and the electric machine temperature.

18. The fuel cell system of claim 17 wherein the controller is further programmed to adjust the target DC voltage retrieved from the stored lookup table based on state of charge of the traction battery.

19. The fuel cell system of claim 18 further comprising a second traction battery coupled to the DC bus by a third DC/DC converter, wherein the controller is programmed to control the third DC/DC converter to supply the target DC voltage to the DC bus.

20. The fuel cell system of claim 19 further comprising a second fuel cell coupled by a fourth DC/DC converter to the DC bus, wherein the controller is programmed to control the fourth DC/DC converter to supply the target DC voltage to the DC bus.
